(19) United States
(12) Patent Application Publication
(10) Pub. No.: US 2002/0182400 A1
(43) Pub. Date: Dec. 5, 2002

(54) Controlled opacity film for viewing in reflected and transmitted light

(76) Inventors: Pang-Chia Lu, Pittsford, NY (US); Jeffrey J. O'Brien, Walworth, NY (US)

Correspondence Address: ExxonMobil Chemical Company, P.O. Box 2149, Baytown, TX, 77522, US

(21) Appl. No.: 09/826,116

(22) Filed: Apr. 4, 2001

(51) Int. Cl. B32B 27/00

(52) U.S. Cl. 428/319.9; 428/213; 428/317.9; 428/317.1

(57) ABSTRACT

A semi-opaque cavitated multilayer plastic film suitable for packaging and labeling applications, and having at least one image applied to an outer skin surface thereof. The film includes a whitening agent in at least one layer, and preferably includes an optical brightener to enhance the lightness of the image. The controlled opacity of the film allows optimal viewing of the image in both reflected and/or transmitted light.

### BACKGROUND OF THE INVENTION

The present invention relates to films for packaging and labeling and, more particularly, to films having controlled opacity for optimized viewing of an image in both transmitted and/or reflected light.

Images applied to currently available films used for packaging and labeling applications generally appear flat and stark in color. These limitations are believed to be due to the inherent visual properties of the available films and the images or designs that they carry, when viewed in reflected light. Particularly, these limitations include limited perception of depth and lack of richness and warmth of color. Moreover, currently available films which allow viewing of an image in transmitted light often exhibit the undesirable characteristics referred to as visual see-through, i.e., the ability to view the light source behind the film structure.

There is therefore a need in the art for packaging and labeling films which are capable of enhancing the visual properties of images applied thereon. Such films would be suitable for viewing in multiple illumination modes, including both transmitted and reflected light, or a combination thereof. In particular, there is a need for films which provide better depth perception and warmth of color whereby more realistic images are achieved, and which allow viewing in transmitted light without visual see-through, thereby enhancing customer and/or consumer appeal.

### SUMMARY OF THE INVENTION

The present invention, which addresses the needs of the prior art, provides a cavitated multilayer plastic film for imaging applications in both reflected and transmitted light. The film includes a polypropylene core layer including from about 3% to about 7% by weight of a cavitating agent and having an uncavitated thickness (expressed as G in mil), the core layer having a first and a second surface. The film includes a polypropylene top tie layer intimately contacting the first surface of the core layer including and an amount of a whitening agent sufficient to cause light reflection therefrom for effective viewing in the imaging applications. The film includes a polyolefin top skin layer intimately contacting the top tie layer. The film includes a polypropylene bottom tie layer intimately contacting the second surface of the core layer. The film includes a polypropylene bottom skin layer intimately contacting the bottom tie layer and including an antiblock agent. The total thickness of the cavitated film is from about 1 mil to about 3 miL. The thickness of the cavitated core layer is from about 30% to about 90% of the total film thickness. The film has a percent light transmission (LT) of less than about 35%. The film substantially prevents visual imaging of a light source viewed through the film while allowing sufficient light transmission of the imaging applications. Finally, the film has a lightness value in transmitted mode (L*) of greater than about 50.

In one preferred embodiment, the cavitating agent contained in the core layer is polybutylene terephthalate. The top tie layer of this film includes about 4% by weight of TiO₂. The top skin layer of this film is formed from a polypropylene-ethylene copolymer. The bottom tie layer of this film includes up to about 4% by weight of TiO₂. Finally, at least one of the layers of this film includes an amount from about 0.05% to about 0.5% of an optical brightener.

As a result, the present invention provides a packaging and labeling film which is capable of enhancing the visual properties of images applied thereon. The film is suitable for viewing in multiple illumination modes, including both transmitted and reflected light, or a combination thereof. The films provide better depth perception and warmth of color whereby more realistic images are achieved, and allow viewing in transmitted light without visual see-through, thereby enhancing customer and/or consumer appeal.

### DETAILED DESCRIPTION OF THE INVENTION

The multilayer plastic films of the present invention suitable for viewing in reflected and/or transmitted modes are formed from at least five layers (L1, L2, L3, L4 and L5). The films are formed from a cavitated polyolefin core layer (L3) sandwiched between a top tie layer (L2) and a bottom tie layer (L4), and bounded on the top and bottom surfaces by a top skin layer (L1) and a bottom skin layer (L5), respectively. An image is located on the surface of the top skin layer (L1). For optimal illumination of the image, such image is preferably transparent or translucent.

Core layer (L3), which is preferably formed from a polyolefin such as isotactic polypropylene, includes from about 3% to about 7% by weight of a cavitating agent. One particularly preferred cavitating agent is polybutylene terephthalate (PBT). Preferably, from about 3% to about 5%, and optimally about 4%, of the cavitating agent is included in the core layer. The cavitated core layer has a thickness that contributes from about 30% to about 90% of the total film thickness.

The film is preferably stretched about 5 times to about 5.5 times in the machine direction and about 8-9 times in the transverse direction. Biaxial stretching orients the polymer molecules along the perpendicular stretched axes parallel to the surfaces of the film. Biaxial orientation imparts other desirable physical characteristics to the film, including increased tear strength and heat shrinkage properties. Increasing the content of a micro-particulate cavitating agent in the core layer increases the abundance of microvoids in the stretched film, contributing to lowering the overall density of the film. The voids also impart a pearlescent reflectivity to the film.

The top tie layer (L2), which is preferably formed from polypropylene, is located on one surface of the core layer designated as the top surface. The top tie layer includes a whitening agent, and may further include an optical brightener. The preferred whitening agents include TiO₂, CaCO₃, BaSO₄, ZnS, MgCO₃, clay, silica, talc, kaolin or any other highly reflective white compound. TiO₂ is a particularly favored whitening agent for use in the films of the present invention.

Up to about 10% by weight of TiO₂ may be included in the top tie layer to enhance whiteness of the film and reflect light through a layer containing a colored tint to brighten any affixed or printed image applied to the film. In one embodiment, the film includes about 8% of TiO₂. Inclusion of from about 2% to about 6% TiO₂ in the film is preferred. Optimally, about 4% of TiO₂ is incorporated into the top tie layer of the films of the present invention.

The bottom tie layer (L4), which is also preferably formed from polypropylene, is located on the other surface of the core layer designated as the bottom surface. The bottom tie layer may include a whitening agent and may include an optical brightener. Preferably, the bottom tie layer has the same compositions of additives and identical amounts of each as the top tie layer compositions and amounts.

One of the outer skin layers of the films of the invention, herein designated as the top skin layer (L1), is formed from a polyolefin. The top skin layer may include one or more colored tint compounds. The second outer skin layer is herein referred to as the bottom skin layer (L5), and is formed from polypropylene. This bottom skin layer may also include an antiblocking additive for improved machining properties.

Polyolefins useful in forming the top skin layer include polyolefin terpolymers, polyolefin copolymers and polyolefin homopolymers. Examples of polyolefin polymers that are particularly useful for forming the top skin layer include propylene-ethylene-butylene terpolymers, propylene-ethylene copolymers, high-density polyethylene polymers, medium density polyethylene polymers, low density polyethylene polymers, and polypropylene or blends of any of the above polyolefins. Preferably, the top skin layer is formed from a propylene-ethylene copolymer, which imparts heat-sealing properties to the film.

As mentioned, tie layers (L2, L4) may include an optical brightener to enhance the optical properties of the film. Optical brighteners are typically fluorescent agents that absorb energy in the ultraviolet region and emit light largely in the blue region.

Optical brighteners include 4,4′-diaminostilbene-2,2′-disulfonic acid, derivatives of 4,4′-diamino-stilbene-2,2′-disulfonic acid, coumarin derivatives such as 4-methyl-7-diethylamino-coumarin, 1,4-bis(O-cyanostyryl)benzol, 2-amino-4-methyl-phenol, and 2,2′-(1,2-ethene-diyldi-4,1-phenylene) benzoxazole. Examples of preferred optical brighteners include Eastobrite® OB-1 produced by Eastman Chemical Company, USA and Horstalux® produced by BASF.

The inclusion of up to about 2% by weight of an optical brightener in the mentioned layers is contemplated in the present invention. Preferably, from about 0.05% to about 0.5% optical brightener is included in one layer. More preferably, the film includes about 0.1% of an optical brightener. Optimally, about 0.2% of an optical brightener is included in a single layer, most preferably the top tie layer.

The addition of a colored tint to any layer of the film structure is contemplated herein, with the addition of one or more colored tints to the top skin layer being particularly preferred. The colored tint or tints should preferably not exceed 2% by weight of any particular layer. More specifically, the addition of one or more colored tints up to about 0.2% by weight of the total film layer is contemplated, with about 0.005% to about 0.15% being preferred, and about 0.007% to about 0.1% being optimal.

In one embodiment of the present invention, the film includes a red tint. This red tint may be an acridone tint, e.g., a quinacridone or a derivative of a quinacridone. An example of a particularly preferred red tint useful in enhancing the optical properties of the films of the present invention is the acridone tint, RT-790 produced by Ciba-Geigy.

In another embodiment of the present invention, the colored tint included in one or more layers of the film is a blue tint. The blue tints enhance the visual whiteness of the film. For marketing appeal a white plastic film with slight bluish tinge is preferred. The blue tints useful for providing enhanced optical properties in the films of the invention include blue dyes and blue pigments. Blue dyes may suffer from photo-bleaching, whereas blue pigments are more stable to light, and are preferred.

Blue pigments useful in the films of the present invention include phthalocyanine blue pigments, cromophtal blue pigments, irgazin blue pigments and irgalite organic blue pigments. Other blue pigments that may be incorporated into the film layers include cobalt aluminate pigments and cobalt chromium aluminate inorganic blue pigments. An example of a particularly preferred blue tint is the Cobalt Blue tint, Sheppard Blue 214 produced by Sheppard Chemical Company.

Films with the red and blue tints and an optical brightener added into one or more layers of the film exhibit an intensified clarity and brightness of the printed image. In addition, the image resolution is greatly improved. As a result, such films are particularly suitable for packaging and label applications where high image quality is desired.

Preferably, the whitening agent is not included in any layer that contains a colored tint. Additionally, the whitening agent should not be located in a layer between the image and a layer containing a colored tint. This precaution prevents any interference with the image enhancing properties of the tint or tints. Finally, opacity may be further enhanced by the addition of a whitening agent to additional layers of the film.

The films of the present invention may be of any thickness, although films with a total polymer gauge thickness from about 1 mil to about 3 mil are preferred. More preferably, the films have a polymer gauge thickness from about 1.5 mil to about 2.5 mil. Optimally, the polymer gauge thickness of the films is in the range from about 1 mil to about 2 mil. However, cavitation may increase the actual optical gauge thickness by 50% or more.

In a preferred embodiment, the film of the present is formed from about 1 mil of uncavitated polymer gauge. In a particularly preferred embodiment, the thickness of the cavitated core layer is in the range from about 0.80 mil to about 1.1 mil, the top and bottom tie layers are each about 0.15 mil to about 0.25 mil in thickness and the total cavitated thickness of the film is about 1.5 mil.

As a result, the present invention provides a film having controlled opacity for optimized viewing of an image in both transmitted and reflected light. This film, which may be deemed semi-opaque, allows this optimized dual mode viewing, but without allowing visual see-through of the light source providing the transmitted light. Particularly, the degree of opacity of the film must be controlled so that the amount of light transmitted through the film is sufficient to allow viewing of the image, but does not allow viewing of the light source behind the film. Simultaneously, the film structure must include an amount of whitening agent and/or exhibit an amount of cavitation sufficient to ensure that an adequate amount of light is reflected form the film structure when viewing the image in reflected light.

One aspect of the present invention provides a multilayer plastic film of an algorithmically defined composition and suitable for packaging and labeling. The film has a controlled opacity and is particularly suitable for imaging applications. The film is optimally viewable in either reflected light or transmitted light, or a combination of reflected light and transmitted light. The film has a polypropylene core layer that includes from about 3% to about 7% by weight of a cavitating agent. In contact on either side of the core layer is a tie layer of polypropylene. The top tie layer includes a whitening agent or white pigment, preferably TiO₂, for reflecting incident light. Positioned below the bottom tie layer is a polypropylene bottom skin layer that includes an antiblock agent. A top layer formed from a polyolefin is positioned above the top tie layer. This top skin layer is suitable to receive an image that may be printed, affixed or applied onto the exposed surface of the top skin layer. The film composition being defined by an algorithm as follows:

V=4.54−1.33 G−1.02 B−0.609 T

where V is the Visual See-Through rating of the film on a 5 point scale; G is the thickness of the uncavitated core layer in mil; B is the percent by weight of the cavitating agent; and T is the percent by weight of TiO₂ in the film.

Another aspect of the present invention provides a multilayer plastic film of an algorithmically defined composition and suitable for packaging and labeling. The film has a controlled opacity and is particularly suitable for imaging applications. The film is optimally viewable in either reflected light or transmitted light, or a combination of reflected light and transmitted light. The film has a polypropylene core layer that includes from about 3% to about 7% by weight of a cavitating agent. In contact on either side of the core layer is a tie layer of polypropylene. The top tie layer includes a whitening agent or white pigment, preferably TiO₂, for reflecting incident light. Positioned below the bottom tie layer is a polypropylene bottom skin layer that includes an antiblock agent. A top layer formed from a polyolefin is positioned above the top tie layer. This top skin layer is suitable to receive an image that may be printed, affixed or applied onto the exposed surface of the top skin layer. The film composition being defined by an algorithm as follows:

LT=34.7−2.40 G−1.85 B−2.04 T

where LT is the percent light transmission of the film; G is the thickness of the uncavitated core layer in mils; B is the percent by weight of the cavitating agent; and T is the percent by weight of TiO₂ in the film.

Still another aspect of the present invention provides a multilayer plastic film of an algorithmically defined composition and suitable for packaging and labeling. The film has a controlled opacity and is particularly suitable for imaging applications. The film is optimally viewable in either reflected light or transmitted light, or a combination of reflected light and transmitted light. The film has a polypropylene core layer that includes from about 3% to about 7% by weight of a cavitating agent. In contact on either side of the core layer is a tie layer of polypropylene. The top tie layer includes a whitening agent or white pigment, preferably TiO₂, for reflecting incident light. Positioned below the bottom tie layer is a polypropylene bottom skin layer that includes an antiblock agent. A top layer formed from a polyolefin is positioned above the top tie layer. This top skin layer is suitable to receive an image that may be printed, affixed or applied onto the exposed surface of the top skin layer. The film composition being defined by an algorithm as follows:

L*=64.3−2.22 G−1.64 B−1.68 T−2.23 G²

where L* is the lightness value of the film; G is the thickness of the uncavitated core layer in mils; B is the percent by weight of the cavitating agent; and T is the percent by weight of TiO₂ in the film.

Other additives that may be usefully incorporated into one or more layers of the films include antistatic agents, anti-condensing agents and anti-oxidants. Examples of suitable antistatic agents include such compounds as cocoamine, N,N-bis(2-hydroxyethyl)sterylamine, or any of a variety of monoamines, diamines and tertiary amines well known in the art. The anti-condensing agent may be any anti-condensing agent such as for instance a fluoropolymer. The anti-oxidant may be any anti-oxidant, such as for example a phosphite.

Further useful additives that may be incorporated into one or both surface or skin layers of the films of the present invention include antiblock agents and slip agents. These additives are incorporated into the films to prevent sticking and to reduce the coefficient of friction, respectively. These properties improve the characteristics of the films for ease of manufacturing and processing, particularly in modern high-speed machinery for rolling and packing.

Antiblock agents and slip agents include various forms of coated or uncoated silica, silicones, siloxanes, silicon oils and cross-linked silicones. Other useful anti-block/slip agents also include for example methyl acrylate and the non-migratory slip agents as well as many others well known in the art.

Particularly useful non-migratory slip agents include ethylene vinyl alcohol (EVOH) and ethylene vinyl acetate (EVA). Preferably the antiblock is included in a skin layer or applied onto the exposed surface of a skin layer. Optimally, the anti-block/slip agent is included in the bottom skin layer, or applied onto the exposed surface of the bottom skin layer.

Up to about 1% of an antiblock agent or slip agent may be included in a skin layer of the films of the invention. More preferably, from about 0.1% to about 0.5% of the antiblock agent or slip agent, and optimally, from about 0.15% to about 0.25% of the antiblock agent or slip agent may be included in the skin layer. Most preferably, the antiblock agent or slip agent is included in the bottom skin layer and one or more colored tints, when present, are included in the top skin layer.

The films of the present invention may be treated on one or both of the exposed surfaces of the top skin layer to improve the functionality of the surface(s), including for example, receptivity for printed images and designs, particularly for water-based inks, or for adherence of affixed label. Such surface treatments may include corona treatment, flame treatment, metalizing treatment or vacuum deposition and other surface treatment methods well known in the art. Treatment of the exposed outer surface of the top skin layer is preferred.

The films of the invention are particularly useful for receiving digital images, which may be applied from an ink jet printing or a thermal transfer process. Alternatively, the films may receive images transferred from a master printing plate or applied via an intermediate substrate. Such methods are especially useful for particularly demanding individualized printing applications, such as for instance, for bar coding or for differential numbering, such as sequential individual numbering of packaged or labeled items.

In a particular embodiment the invention provides a five layer plastic film for imaging and suitable for viewing in reflected and transmitted modes, formed from the following: a top skin layer of a polyolefin suitable for receiving an image; a top tie layer also of polypropylene; a core layer of polypropylene and about 4% of a cavitating agent; a bottom tie layer also formed from polypropylene; and a bottom skin layer of polypropylene and an antiblock agent; wherein: the top or bottom tie layers, or both comprise one or more whitening agents, such that the light transmission by the film is less than about 33%, and L*, the lightness value of the film is from about 50% to about 62%.

### EXAMPLES

The following examples of white and color tinted semi-opaque films with controlled opacity for imaging applications in reflected and transmitted modes are provided for illustration of the invention only and should not be construed as limiting in any way. For the purposes of the present invention, semi-opaque property of a film means the property of having sufficient opacity to allow effective viewing of an image or design on the film in reflected light, but preventing viewing of a light source or lighted image behind the film.

### Example 1

The following films particularized in Table I, were produced in a 5-layer polymer structure of 1.5 mil total cavitated thickness and 1.0 mil uncavitated polymer gauge. The core layer (L3) was formed from polypropylene. The top tie layer (L2) and the bottom tie layer (L4) were each 3 gauge in thickness and each included 0.2% by weight of an optical brightener and the specified amount of TiO₂. The top skin layer (L1) was formed from a propylene-ethylene copolymer, and the bottom skin layer (L5) included an antiblock additive.

Table I shows the measured optical properties including the % Light Transmission, the Visual See-through Rating and the Lightness of the semi-opaque films.

TABLE I

| | | | | L2/L4 gauge | | V (Visual | |
|---|---|---|---|---|---|---|---|
| | L3 | | | (varies, | | see-through | |
| | Uncavitated | | TiO₂ in | depending | | rating) | L* (lightness in |
| | Gauge | PBT in L3 | L2/L4 | on L3 | LT (% light | 1 = none | transmitted |
| Sample # | (G in mil) | (%) | (%) | gauge mil) | transmission) | 5 = bad | mode) |
| 1 | 0.44 | 3 | 0 | 0.25 | 42.6 | 5 | 69.1 |
| 2 | 0.54 | 3 | 0 | 0.20 | 40.3 | 5 | 68.7 |
| 3 | 0.64 | 3 | 0 | 0.15 | 37.1 | 5 | 64.7 |
| 4 | 0.64 | 7 | 0 | 0.15 | 30.8 | 1 | 58.7 |
| 5 | 0.44 | 7 | 0 | 0.25 | 37.7 | 5 | 64.6 |
| 6 | 0.54 | 7 | 0 | 0.20 | 34.3 | 2 | 62.3 |
| 7 | 0.54 | 5 | 2 | 0.20 | 35.7 | 5 | 68.0 |
| 8 | 0.44 | 5 | 2 | 0.25 | 36.6 | 5 | 64.6 |
| 9 | 0.64 | 5 | 2 | 0.15 | 33.6 | 2 | 61.7 |
| 10 | 0.64 | 3 | 2 | 0.15 | 30.7 | 1 | 58.7 |
| 11 | 0.44 | 3 | 2 | 0.25 | 35.0 | 5 | 62.8 |
| 12 | 0.54 | 5 | 2 | 0.20 | 34.7 | 5 | 62.7 |
| 13 | 0.64 | 5 | 4 | 0.15 | 28.6 | 1 | 57.2 |
| 14 | 0.44 | 5 | 4 | 0.25 | 34.4 | 5 | 62.7 |
| 15 | 0.54 | 3 | 4 | 0.20 | 37.5 | 5 | 64.7 |
| 16 | 0.54 | 7 | 4 | 0.20 | 31.0 | 1.5 | 59.6 |
| 17 | 0.44 | 7 | 4 | 0.25 | 33.2 | 2 | 62.1 |
| 18 | 0.64 | 7 | 4 | 0.15 | 29.9 | 1 | 58.3 |

Films having a LT value of less than 33% showed excellent opacity with no visual see through. The opacity was controlled by varying the following parameters: the thickness of the core layer (L3); the amount of cavitating agent in L3; and the amount of TiO₂ in the tie layers (L2 and L4).

The films showed L* values (in transmitted mode) larger than 50, indicating that the films were all very bright in appearance, and were suitable for use with a white background for reflectivity.

### Example 2

The following films were produced in accordance with Example 1, with the following exceptions: Various amounts of optical brightener (OB) were added to the tie layers (L2 and L4). Blue tint was to skin layer (L1) to enhance the white appearance.

TABLE II

| | | | | | L2/L4 | | | L* (lightness in |
|---|---|---|---|---|---|---|---|---|
| | OB in | TiO₂ in | OB in | guage | LT (% light | L* (in reflective | transmission | |
| Sample # | L2 (%) | L2 (%) | L4 (%) | TiO₂ in L4 (%) | (mil) | transmission) | mode) | mode) |
| 1 | 0.2 | 4 | 0 | 0 | 0.25 | 32.7 | 98.68 | 61.15 |
| 2 | 0.1 | 4 | 0 | 0 | 0.25 | 33.4 | 98.03 | 61.43 |
| 3 | 0.2 | 2 | 0 | 0 | 0.25 | 34.8 | 98.97 | 63.77 |
| 4 | 0.1 | 2 | 0 | 0 | 0.25 | 34.5 | 97.80 | 62.58 |
| 5 | 0.2 | 0 | 0.2 | 0 | 0.15 | 30.8 | 98.66 | 59.78 |
| 6 | 0.2 | 4 | 0 | 2 | 0.25 | 32.2 | 98.55 | 61.60 |
| 7 | 0.1 | 4 | 0 | 2 | 0.25 | 32.2 | 97.99 | 60.61 |
| 8 | 0.2 | 4 | 0 | 4 | 0.25 | 33.0 | 98.67 | 60.64 |
| 9 | 0.1 | 4 | 0 | 4 | 0.25 | 31.8 | 98.00 | 59.52 |
| 10 | 0.2 | 0 | 0 | 4 | 0.25 | 35.5 | 98.42 | 62.71 |
| 11 | 0.2 | 0 | 0 | 9 | 0.25 | 33.1 | 98.44 | 61.14 |
| 12 | 0.1 | 0 | 0 | 4 | 0.25 | 34.3 | 98.17 | 62.78 |

When measured in reflective mode, a white ceramic tile was placed behind the film, with the tinted side toward the light source. When measured in transmission mode, the sample was placed between the light source and sensor, with the tinted side away from the light source.

The percent light transmission was controlled by the thickness of the cavitated core layer, and the amount of TiO₂ added to the total film structure. The surface lightness (L*) of the film was primarily influenced by the amount of TiO₂ and OB in tie layer (L2).

It will be appreciated that the present invention has been described herein with reference to certain preferred or exemplary embodiments. The preferred or exemplary embodiments described herein may be modified, changed, added to or deviated from without departing from the intent, spirit and scope of the present invention, and it is intended that all such additions, modifications, amendments and/or deviations be included within the scope of the following claims.

What is claimed is:

1. A cavitated multilayer plastic film for imaging applications in both reflected and transmitted light, comprising:
(i) a polypropylene core layer including from about 3% to about 7% by weight of a cavitating agent, the core layer having a first and a second surface;
(ii) a polypropylene top tie layer intimately contacting the first surface of the core layer including an amount of a whitening agent sufficient to cause light reflection therefrom for effective viewing in said imaging applications;
(iii) a polyolefin top skin layer intimately contacting the top tie layer;
(iv) polypropylene a bottom tie layer intimately contacting the second surface of the core layer;
(v) a polypropylene bottom skin layer intimately contacting the bottom tie layer and including an antiblock agent;
wherein the total thickness of the cavitated film is from about 1 mil to about 3 mil, and wherein the thickness of the cavitated core layer is from about 30% to about 90% of the total film thickness, and wherein the film has a percent light transmission (LT) of less than about 35%; wherein the film substantially prevents visual imaging of a light source viewed through the film while allowing sufficient light transmission for said imaging applications, and wherein the film has a lightness value in transmitted mode (L*) of greater than about 50.

2. The film according to claim 1, wherein the percent light transmission (LT) of the film is less than about 33%, and the lightness value (L*) of the film is from about 50% to about 62%.

3. The film according to claim 1, wherein:
(i) the cavitating agent is polybutylene terephthalate;
(ii) the top tie layer includes about 4% by weight of TiO₂;
(iii) the polyolefin polymer of the top skin layer is a propylene-ethylene copolymer;
(iv) the bottom tie layer includes up to about 4% by weight of TiO₂; and
wherein at least one of the layers includes an amount from about 0.05% to about 0.5% of an optical brightener.

4. The film according to claim 1, wherein:
(i) the thickness of the uncavitated core layer is from about 0.44 mil to about 0.64 mil;
(ii) each of the top and the bottom tie layers has a thickness of from about 0.15 mil to about 0.25 mil; and
(iii) the total cavitated thickness of the film is about 1.5 mil.

5. The film according to claim 1, wherein the top skin layer further comprises a tint selected from the group consisting of: a blue tint, a red tint, and both a blue tint and a red tint.

6. The film according to claim 1, further comprising an image formed of a transparent dye or a translucent dye, and wherein the image is applied, thermally transferred, coated or printed onto the exposed surface of the top skin layer.

7. The film according to claim 1, wherein the white pigment of the top tie layer is TiO₂.

8. The film according to claim 7, wherein the thickness (G mil) of the uncavitated core layer, the percent by weight (B) of the cavitating agent, and the percent by weight (T) of the TiO₂, are given by the algorithm:
V=4.54−1.33 G−1.02 B−0.609 T
wherein V is the Visual See-Through rating of the film.

9. The film according to claim 7, wherein the thickness (G mil) of the uncavitated core layer, the percent by weight (B) of the cavitating agent, and the percent by weight (T) of the TiO₂, are given by the algorithm:
LT=34.7−2.40 G−1.85 B−2.04 T
wherein LT is the percent light transmission of the film.

10. The film according to claim 7, wherein the thickness in (G mil) of the uncavitated core layer, the percent by weight (B) of the cavitating agent, and the percent by weight (T) of the TiO₂, are given by the algorithm:
L*=64.3−2.22 G−1.64 B−1.68 T−2.23 G²
wherein L* is the lightness value of the film.
